(19) United States
(12) Patent Application Publication
(10) Pub. No.: US 2008/0221974 A1
(43) Pub. Date: Sep. 11, 2008

(54) Lazy Evaluation of Bulk Forecasts

(76) Inventors: Alexander Gilgur, Sunnyvale, CA (US); Yuval Levin, Los Altos, CA (US); Michael F. Perka, Mountain View, CA (US); Dale Quantz, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/036,167

(22) Filed: Feb. 22, 2008

Related U.S. Application Data
(60) Provisional application No. 60/891,043, filed on Feb. 22, 2007.

(51) Int. Cl. G07G 1/00

(52) U.S. Cl. 705/10

(57) ABSTRACT

Evaluation of data models and forecasts is provided, enabling processing of large numbers of forecast scenarios in a production environment. An approach for optimizing the computation for statistical modeling and forecasting is described. This approach includes calculating a recommended number of collected data points, calculating a cap on time to elapse, deciding based on at least one of the recommended number of collected data points and the cap on time to elapse whether to generate a forecast model and generating a forecast model from the collected data points.

### CROSS-REFERENCE TO RELATED APPLICATIONS

This application claims the benefit of U.S. provisional application 60/891,043, filed on Feb. 22, 2007, incorporated by reference herein in its entirety.

This application is also related to U.S. patent application Ser. No. 11/823,111 titled “Evaluation of Data Models and Forecasts,” filed on Jun. 25, 2007, and incorporated by reference herein in its entirety.

### BACKGROUND

1. Field of the Invention

The present invention relates generally to computer-implemented modeling and forecasting, specifically to applications in which large numbers of scenarios have to be processed in a batch. The present invention can be used to reduce the number of scenarios forecasted in each batch, in order to optimize the time required to perform those forecasts. A tool is provided that allows a user to automatically create a timeline for regenerating forecasts for the scenarios that have been processed.

2. Description of the Related Art

A forecast is a prediction or estimate of an actual value in a future time period called a forecast horizon, for a time series or for another situation for cross-sectional data.

A bulk forecast is denotes a union of forecasts for any number of scenarios greater than one.

One approach to bulk processing of large amounts of forecasts is to process every scenario each time a bulk forecast is requested. This is not an efficient solution, as some of the scenarios will not have accumulated enough data points to make the forecast significantly different from the one that is stored from a previous run, and in addition the data may have started displaying patterns that have not been observed before. Reevaluating scenarios during such transitional periods before the patterns have fully established themselves risks lowering the model and forecast quality for the scenario.

### SUMMARY

The present invention optimizes the computation for statistical modeling and forecasting by providing forecasts only for those scenarios where the actual data have come outside confidence guardbands established by the previous forecast, and forecasting, for each scenario, the number of data points that need to be collected before the next forecast is provided. This approach reduces the overall workload on a central processing unit (CPU) and input/output (I/O) devices, and yields a more meaningful forecast.

In one embodiment, a system of the present invention determines whether to reevaluate a forecast model, the determination made based on at least one of a data behavior over the forecast horizon; recommended number of collected data points; and the cap on time to elapse; and generates a forecast model from the collected data points. In addition, in one embodiment, statistical process control techniques are applied to ensure that forecasts for each scenario are recalculated before the data fall outside the guardbands determined in the previous forecast for each scenario.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates components of a scenario.

FIG. 2 is a flow chart illustrating a method for forecast modeling in accordance with an embodiment of the present invention.

FIG. 3 illustrates a feedback loop for a forecast scenario in accordance with an embodiment of the present invention.

FIGS. 4 and 5 provide a pseudo code algorithm for a Recommended Number of Collected Data points, or RNCD, and Cap on Time To Elapse, or CTTE calculator program as implemented in an embodiment of the present invention.

FIG. 6 provides an illustration of a concept of unscheduled forecasts on outliers with reference to the data.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

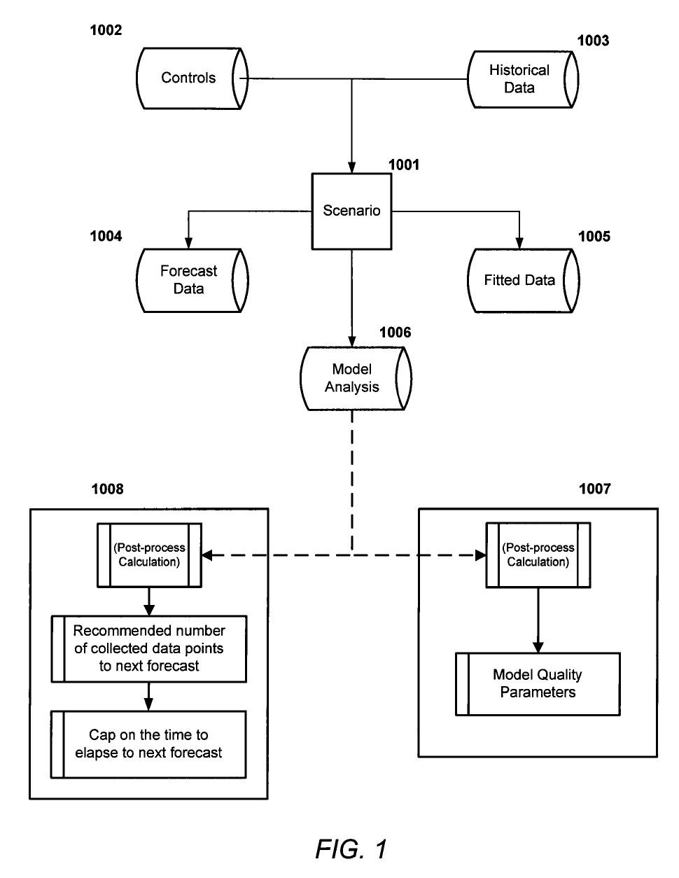

FIG. 1 illustrates the anatomy of a scenario in accordance with an embodiment of the present invention. A Scenario 1001 includes controls 1002, historical data 1003, forecast data 1004, fitted data 1005, and analysis 1006. In turn, analysis 1006 includes data and information that can be used to calculate model quality parameters 1007 and the recommended number of collected data points, or RNCD, to the next forecast, as well as a cap on time to elapse, or CTTE, to the next forecast 1008.

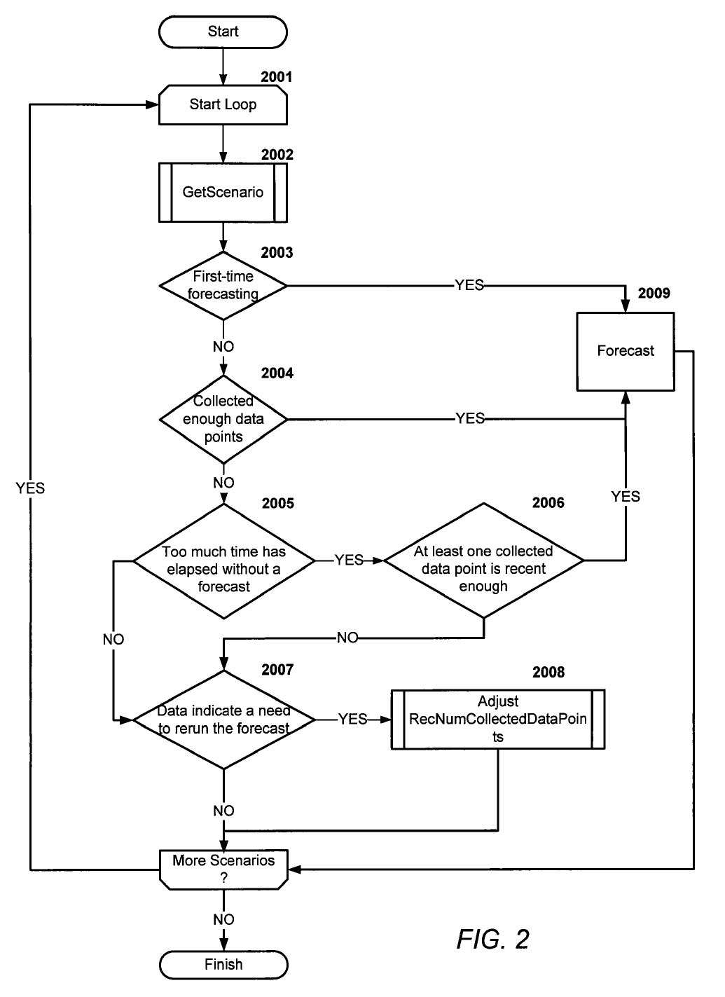

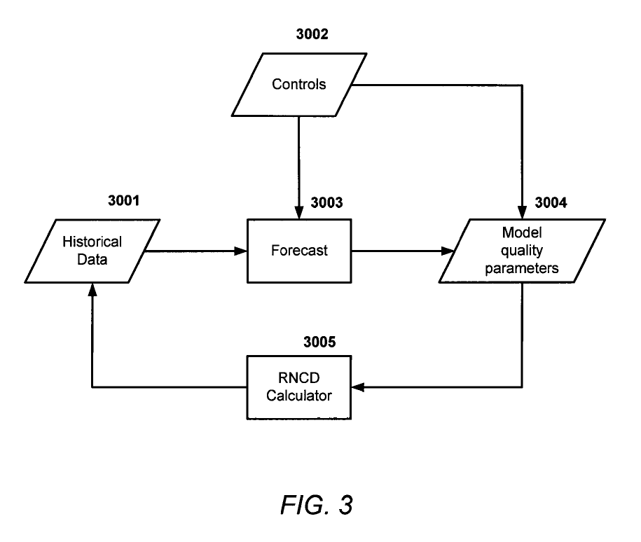

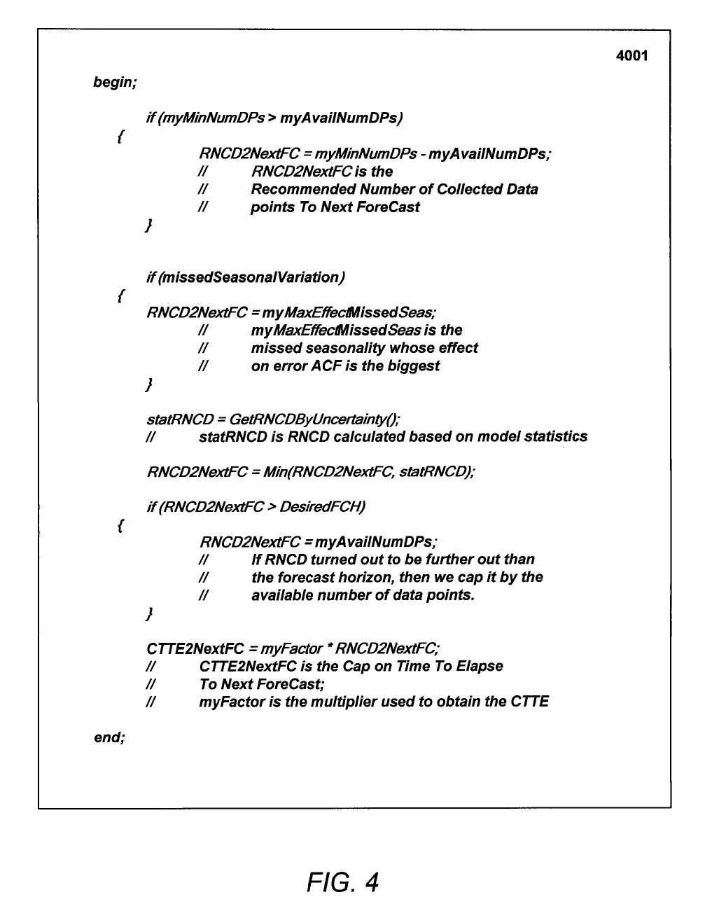

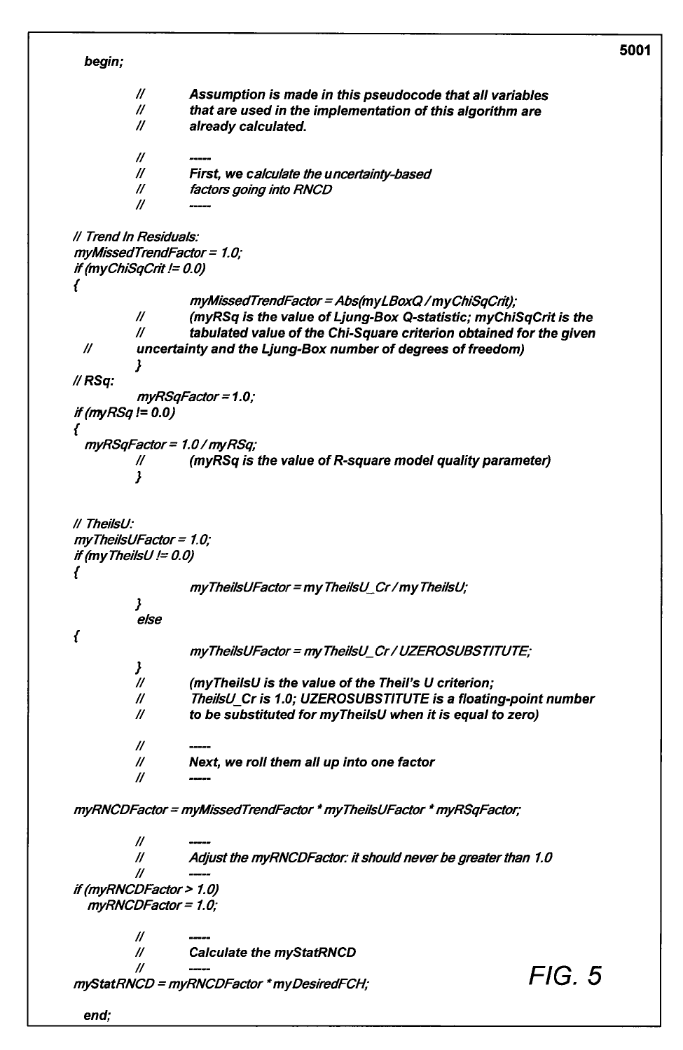

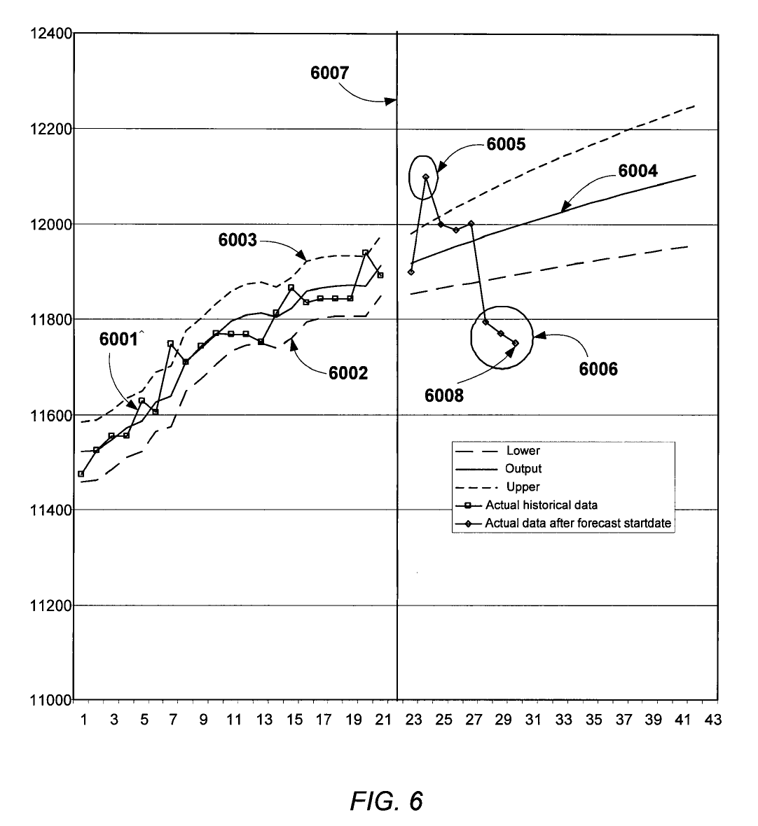

Referring again to FIG. 2, there is shown a method for bulk forecasting in accordance with an embodiment of the present invention. The Forecast module 3003 (FIG. 3) starts loop 2001 through all scenarios that it stores. For each scenario 2002, the system checks 2003 information stored in association with scenario controls to determine whether this scenario has ever been forecasted. If not, then the system checks 2004 whether the number of the collected data points since the last forecast is greater than the RNCD calculated at the previous run of the system. If the system has accumulated some data points since the last forecast, but not enough, and has been idle 2005 for a sufficiently long time, e.g., longer than the CTTE—cap on time to elapse, then after the next data collection 2006, a forecast is produced for the scenario. If the RNCD requirement has been met, or the CTTE has elapsed, then the forecast 2009 is recomputed, and the new RNCD and cap recalculated as a function of the data quality and model/forecast goodness of fit. The algorithm is outlined in the pseudo-code in FIGS. 4 and 5. In addition, a check is made 2007 whether the freshly collected data indicate a significant deviation from the previous forecast, as illustrated in FIG. 6, i.e., the data fall outside the previously calculated forecast guardbands for more than one collection period. If they do, then the RNCD is adjusted 2008 to a value sufficient to ensure that the outlier data point (the latest data point significantly deviating from the previous forecast) is not the last point in the time series. By doing so, we avoid triggering forecasts on outliers.

The value sufficient to ensure that the outlier data point is not the last point calculated for RNCD, in one embodiment is defined as two data points after the outlier.

FIG. 3 illustrates a system architecture including a RNCD Calculator module 3005 in accordance with an embodiment of the present invention. HistoricalData 3001 and Controls 3002 provide the information needed to Forecast module 3003, which generates ModelQualityParameters 3004, based on which RNCD calculator 3005 evaluates the control (number of data points needed) for the HistoricalData 3001. The RNCD Calculator module 3005 has multiple functionalities including performing the calculation of RNCD (Recommended Number of Collected Data points) and CTTE (Cap on Time to Elapse). A Forecast module 3003 picks the scenarios for which forecasts are due to be regenerated based on the RNCD estimated by the RNCD Calculator, Historical Data 3001, and controls 3002, and performs the forecasting. Their general functionality is outlined in FIG. 2.

In one embodiment, a method for performing bulk forecasting in accordance with the present invention includes determining a RNCD (Recommended Number of Collected Data points); determining a CTTE (Cap on Time To Elapse); determining when to override the calculated RNCD and CTTE; and forecasting feedback.

RNCD is calculated based on the size of the dataset and based on the model uncertainty, after which the two are compared and the smaller number of the two is selected. An overall shell of a method algorithm 4001 for determining RNCD and CTTE in accordance with an embodiment of the invention is presented FIG. 4. The Model Analysis module estimates whether there are enough datapoints to support a statistical confidence of the forecast, and if not, it sets the RNCD value to the number of additional datapoints that need to be collected. If the historical data showed a seasonal (periodic) variation, then the RNCD is set to the period of this seasonality. Finally, model-uncertainty-based RNCD is evaluated (5001, FIG. 5). After that, if the smallest of the RNCDs is greater than the desired forecast horizon, then the RNCD value is set to the number of historical datapoints used in forecasting. FIG. 4 illustrates a general algorithm used in the calculation 4001. We calculate RNCD from three different sources, i.e., data quality; missed seasonalities, and model uncertainty, and get the smallest of the three. After that is done, we obtain the CTTE as a number proportional to RNCD.

FIG. 5 illustrates the calculation of RNCD based on model uncertainty in accordance with an embodiment of the present invention. In one embodiment, RNCD is evaluated as a multiplier of the Forecast Horizon. First, the RNCD Calculator 3005 (FIG. 3) determines how well the model caught the trends in data and, if any trend has been missed, it is evaluated as a Ljung-Box Q-statistic, which is an estimate of randomness of residuals. The smaller the Q, the higher the certainty that the residuals are random and consequently the RNCD Forecast Horizon multiplier becomes smaller. Conversely, if the model missed a trend, then the residuals are not random, and the RNCD increases to allow collection of more data prior to the next forecast. The overall model's goodness of fit is then evaluated based on the coefficient of determination (R²). Smaller R² values indicate a poor model fit and therefore its reciprocal is part of the RNCD Forecast Horizon multiplier. Smaller R² values imply that more data should be accumulated. Finally, Theil's U—a relative measure of forecast quality—is calculated, and its reciprocal is also included in the calculation of the RNCD Forecast Horizon multiplier, which is a product of the three factors described above. That done, a product of the forecast horizon and the multiplier is returned as the RNCD based on model uncertainty. An algorithm used in one embodiment of the invention for calculating the RNCD based on model uncertainty 5001 is presented in FIG. 5. It corresponds to the GetRNCDByUncertainty( ) function shown in 4001.

FIG. 6 illustrates the theory behind data-based reevaluation of forecast for a given scenario. The horizontal axis (X) corresponds to the timeline and the vertical axis (Y) corresponds to the data collected and forecasted. Line 6001 represents the historical data, based on which the forecast is calculated. Lines 6002 and 6003 represent the confidence guardbands. Line 6004 represents the data calculated by using the forecasting model. Outlier 6005 is a singular event, after which the data returned within the guardbands. The string of outliers 6006 is a new trend. When the data reaches the third point in that string (data point 6008), an unscheduled forecast will be calculated for this scenario. The vertical line 6007 merely separates the data before the forecast start point from data after such point.

After a forecasting model has been calculated, a variety of model-quality related parameters may be produced. The time before the forecast should be recalculated for a specific scenario is determined in part by model quality-related parameters.

In one embodiment, model parameters include measures for sample size, forecast horizon, model trend, seasonality, degree of correlation (e.g., R²), and forecast quality (e.g., Theil's U). More or fewer parameters may be used in other embodiments.

If the sample size is insufficient as determined by the statistical Student's T-test to support the desired confidence limits, more data is accumulated.

A scenario's forecast horizon imposes a natural cap on the RNCD because it is time to reevaluate the forecast for this scenario when the historical data have reached the forecast horizon.

A model trend may manifest itself as a trend in residuals (differences between the model and the actual data, i.e., model errors). This may mean that the model missed a trend and that the forecast should be reevaluated sooner.

If the model missed any seasonal variation in data, the Forecast module 3003 (FIG. 3) revisits this scenario at its next seasonality period.

Based on evaluating a degree of correlation, such as a coefficient of determination R², if a model does not explain a significant amount of data variance, more data needs to be collected before the forecast for this scenario gets recalculated, therefore the RNCD needs to be greater than if the model already explains all the data variation (FIG. 5). In the latter case, a slight deviation from the model will cause an outlier (data falling outside the guardbands) sooner than if the model leaves a lot of uncertainty behind, like in the former case.

Evaluation of a measure of forecast quality or accuracy, such as Theil's U may help answer the question as to whether the model is better for forecasting than a baseline, which in one embodiment is a simple moving-average extrapolation. If the model is not better than the baseline, more data should be collected.

The impact of each of the parameters of the RNCD is then calculated based on their specific formula and meaning and then they are all rolled up into a multiplicative formula, such that they all contribute to the Recommended Number of Collected Data points. For example, the product of the RNCD factors as described above and outlined in 5001, FIG. 5 is used as the factor by which to multiply Forecast Horizon in order to obtain the value of RNCD for the scenario.

The pseudocode used in one embodiment of the invention for calculating Recommended Number of Collected Data points (RNCD) and Cap on Time To Elapse (CTTE) is presented in FIGS. 4 and 5.

A method for bulk forecasting in accordance with an embodiment of the present invention is illustrated in FIG. 2. A forecast is computed for a scenario if any one of the following four conditions has been met:
1. It is the first time that a forecast is to be computed for this scenario.
2. The number of data points collected since the last forecast is greater than the RNCD calculated in the last run.
3. The number of data points collected since the last forecast is less than the RNCD calculated in the last run, but the Cap on Time To Elapse (CTTE) has expired, and there was at least one data point collected after that.
4. Data indicate the need to rerun the forecast.

When data indicate the need to rerun the forecast, an unscheduled forecast is executed. This allows the system to respond to a significant change in data behavior when the recommended number of collection data points (RNCD) was based on an insufficient size of the data set used in the previous forecast. When there is not enough data to determine the data behavior with a significant degree of confidence, the RNCD calls for collection of all the data that are needed to meet the desired confidence level; however, in such cases the forecaster is unlikely to know of such patterns. To alleviate this problem, in one embodiment, data that fall outside the confidence-imposed data guardbands is identified, and after there is a collected (measured) data point outside the guardbands, the forecast is recalculated.

An unscheduled forecast allows the forecast to remain current with the data. In many cases, the analyst can see that the data started deviating form the patterns predicted by the earlier forecast, enough to change the forecast. When the deviation is statistically significant, the forecast is recomputed.

A variety of rules are used to determine whether the forecast should be rerun. These include tracking data that has come outside the guardbands over several data points: if the data returns into the fold, it must have been an outlier, and so there is no need to reforecast the scenario; tracking data before it came outside the guardband over several data points: a trend in data significantly different from the forecasted trend may be discovered that is strong enough to prompt a rerun of the forecast for this scenario; and the “Westinghouse rules”, known to those of skill in the art for identifying aberrant observations in statistical process control (SPC).

A different logic may be used in RNCD and CTTE calculation, including, but not limited to,

Rerunning forecast after every data collection period when there are not enough data points to support the desired confidence levels, as opposed to rerunning the forecast at the end of a time period equal to the size of the data set. This increases the workload, but provides improved granularity in keeping the forecast current with the data.

Rerunning forecast after a pre-set amount of time if there are not enough data points to support the desired confidence levels.

CTTE may be set to a certain number, rather than proportional to RNCD, e.g., a fixed number of data collection periods.

An alternative way to calculate CTTE may be used, e.g., as a function of data collection frequency independent of RNCD, or a non-linear function of RNCD.

A ranking system determining which scenarios need forecasts regenerated at a higher priority may be used, based a variety of criteria, including, but not limited to,

RNCD,

Analyst's preference,

Completion of previous run.

The present invention provides a robust, unique, economic way to process large amounts of forecast scenarios in a production environment. It is flexible, and it saves time. All the processing is performed automatically, so that the user can simply start the automatic forecast process, or even set a frequency of forecasts for the batch, and the forecasting system utilizing this invention will take care of everything.

The evaluation of bulk forecasts described herein provides an effective method that can be used in production environments, where forecasts need to be provided for large quantities of scenarios and where the user should not need to worry about each individual scenario.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the map image-rendering-software provider, map image provider and so forth may be provided in many or one module.

Some portions of the above description present the feature of the present invention in terms of algorithms and symbolic representations of operations on information. These algorithmic descriptions and representations are the means used by those skilled in the art of data modeling and forecasting to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A computer-implemented method for optimizing runtime and utilization of computer resources in bulk statistical data modeling and forecasting, the method comprising:
determining a recommended number of collected data points as a function of forecast horizon and data and model quality parameters;
determining a cap on time to elapse as a number proportional to the recommended number of collected data points;
determining, based on at least one of data behavior, the recommended number of collected data points, and the cap on time to elapse, whether to generate a forecast model; and
generating the forecast model from all collected data.

2. The method of claim 1, wherein generating the forecast model from the collected data points further comprises employing a control logic for feedback forecasting.

3. The method of claim 1, wherein generating a forecast model from the collected data points comprises recalculating at least one of the recommended number of collected data points and the cap on time to elapse.

4. The method of claim 1, wherein generating a forecast model from the collected data points comprises adjusting the recommended number of collected data points, responsive to collecting at least one outlier data point.

5. The method of claim 4, further comprising recomputing the forecast model responsive to collecting at least two data points past the outlier data point.

6. The method of claim 1, wherein deciding whether to generate a forecast model further comprises calculating at least one model parameter.

7. The method of claim 6, wherein model parameter comprises at least one of a measure of sample size, a measure of forecast horizon, a measure of model trend, a measure of seasonality, a measure of a degree of correlation, and a measure of forecast quality.

8. The method of claim 6, wherein the model parameter contributes to the recommended number of collected data points.

9. The method of claim 1, wherein the cap on time to elapse is proportional to the recommended number of collected data points.

10. The method of claim 1, wherein deciding whether to generate a forecast model further comprises at least one of:
determining whether the forecast model to be generated is the first such model;
determining whether the number of collected data points since the previous forecast model is greater that the recommended number of collected data points calculated for the previous forecast model;
determining whether the number of collected data points since the previous forecast model is less that the recommended number of collected data points calculated for the previous forecast model but the cap on time to elapse has expired and there exists at least one collected data point since the cap on time to elapse expired; and
determining based on the collected data points whether an unscheduled forecast model needs to be generated.

11. The method of claim 10, wherein the unscheduled forecast model is generated responsive to an insufficient number of collected data points in an earlier forecast model and the subsequent availability of sufficient collected data points within a desired confidence level.

12. The method of claim 10, wherein the unscheduled forecast model is generated responsive to the collected data points deviating significantly from patterns predicted by an earlier forecast model.

13. The method of claim 1, further comprising scenarios corresponding to collected data points, the scenarios that need forecasting at a higher priority determined by a ranking system.

14. The method of claim 13, wherein the rank is based on at least one of a recommended number of collected data points, a forecaster's preference, and a completion of an earlier forecast.

15. A computer program product having computer-readable medium having computer program instructions embodied therein for integrating the computation for optimizing runtime and utilization of computer resources in bulk statistical data modeling and forecasting, the computer program product comprising computer program instructions for:
determining a recommended number of collected data points as a function of forecast horizon and data and model quality parameters;
determining a cap on time to elapse as a number proportional to the recommended number of collected data points;
determining, based on at least one of data behavior, the recommended number of collected data points, and the cap on time to elapse, whether to generate a forecast model; and
generating the forecast model from all collected data.

16. The computer program product of claim 15, wherein generating a forecast model from the collected data points comprises employing a control logic for feedback forecasting.

17. The computer program product of claim 15, wherein generating a forecast model from the collected data points comprises recalculating at least one of the recommended number of collected data points and the cap on time to elapse.

18. The computer program product of claim 15, wherein generating a forecast model from the collected data points comprises adjusting the recommended number of collected data points, responsive to collecting at least one outlier data point.

19. The computer program product of claim 18, wherein the outlier data point is the last collected data point in a time series.

20. The computer program product of claim 18, further comprising recomputing the forecast model responsive to collecting at least two data points past the outlier data point.

21. The computer program product of claim 15, wherein deciding whether to generate a forecast model further comprises calculating at least one model parameter.

22. The computer program product of claim 21, wherein model parameter comprises at least one of a measure of sample size, a measure of forecast horizon, a measure of model trend, a measure of seasonality, a measure of a degree of correlation, and a measure of forecast quality.

23. The computer program product of claim 21, wherein the model parameter contributes to the recommended number of collected data points.

24. The computer program product of claim 15, wherein the cap on time to elapse is proportional to the recommended number of collected data points.

25. The computer program product of claim 15, wherein deciding whether to generate a forecast model further comprises at least one of:
determining whether the forecast model to be generated is the first such model;
determining whether the number of collected data points since the previous forecast model is greater that the recommended number of collected data points calculated for the previous forecast model;
determining whether the number of collected data points since the previous forecast model is less that the recommended number of collected data points calculated for the previous forecast model but the cap on time to elapse has expired and there exists at least one collected data point since the cap on time to elapse expired; and
determining based on the collected data points whether an unscheduled forecast model needs to be generated.

26. The computer program product of claim 25, wherein the unscheduled forecast model is generated responsive to an insufficient number of collected data points in an earlier forecast model and the subsequent availability of sufficient collected data points within a desired confidence level.

27. The computer program product of claim 25, wherein the unscheduled forecast model is generated responsive to the collected data points deviating significantly from patterns predicted by an earlier forecast model.

28. The computer program product of claim 15, further comprising scenarios corresponding to collected data points, the scenarios that need forecasting at a higher priority determined by a ranking system.

29. The computer program product of claim 28, wherein the rank is based on at least one of a need to calculate an unscheduled forecast, the recommended number of collected data points, a forecaster's preference, and the completion of an earlier forecast.

30. A system for optimizing runtime and utilization of computer resources in bulk statistical data modeling and forecasting, the system comprising a processor configured to:
determine a recommended number of collected data points as a function of forecast horizon and data and model quality parameters;
determine a cap on time to elapse as a number proportional to the recommended number of collected data points;
determine, based on at least one of data behavior, the recommended number of collected data points, and the cap on time to elapse, whether to generate a forecast model; and
generate the forecast model from all collected data.
